(19) United States
(12) Patent Application Publication
(10) Pub. No.: US 2016/0210505 A1
(43) Pub. Date: Jul. 21, 2016

(54) METHOD AND SYSTEM FOR IDENTIFYING HANDWRITING TRACK

(71) Applicant: SIMPLO TECHNOLOGY CO., LTD., HSINCHU COUNTY (TW)

(72) Inventor: KUAN-CHENG CHIU, TAIPEI CITY (TW)

(21) Appl. No.: 14/728,951

(22) Filed: Jun. 2, 2015

(30) Foreign Application Priority Data
Jan. 16, 2015 (TW) 104101494

(51) Int. Cl. G06K 9/00; G06F 3/0346

(52) U.S. Cl. CPC G06K 9/00409; G06K 9/00154; G06F 3/0346

(57) ABSTRACT

The disclosure is related to a method for identifying handwriting track and a system thereof. The system includes a handwriting device and the control circuits, and the function modules for sensing angular velocity, data sampling, and track comparison. The system samples signals generated by the handwriting device receiving the angular velocity signals. Multiple sampling values within a period of time are obtained. In addition to acquiring the data relating rotation and movement, a rhythm indicating the relationship among the multiple sampling values is also obtained. A handwriting track is depicted according to the angular velocity and angular displacement for every sampling point. The attribute of the handwriting track is therefore the rhythm data recording variance of sampling values per unit time. The system renders modes of handwriting recognition, and character or command input.

### BACKGROUND OF THE INVENTION

1. Field of the Invention

The disclosure according to the present invention is related to a method and a system for identifying handwriting track; in particular to the method and system for identifying handwriting track according to physical quantity of rotation of an object in a space.

2. Description of Related Art

In addition to the ordinary input methods such as using a keyboard or computer mouse adapted to a personal computer, use of a handwriting method is also quite common. One of the handwriting technologies is for a user to manipulate a pen-like device operating over an electromagnetic plate. A track of moving the pen-like device over the plate can be depicted in response to the change to the magnetic field made by the device. One more method is for the user using a handwriting tool to draw the tracks over a touch panel. Some other methods of handwriting to sense the pen-like device moving within an area are such as adopting a sensor to sense the light-blocking signals generated by an infrared emitter and sensing the radio waves reflected by a radio emitter. According to the current technology, a sensor circuit implanted in a handwriting device may be used to itself sense the moving track.

The aforementioned technologies are provided for the user manipulating the handheld device to move over a surface, and the sensors disposed around the surface are used to determine the handwriting track.

Furthermore, the handwriting track of movement of the handheld device in a three-dimensional space can also be depicted with the technology of 3D tracing. In related technology, the user's wearable or handheld device may be an input device disposed with a movement sensor which allows tracing the movement in 3D space. For example, when the user holds the input device waving in 3D space, the movement of the input device generates moving signals. For the purpose of handwriting, the signals are then wirelessly transmitted to a recognition device for projecting the 3D tracks onto a two-dimensional plane.

### SUMMARY OF THE INVENTION

For providing technology for identifying a handwriting track in a three-dimensional space, the embodiments in the disclosure are directed to a method for identifying a handwriting track and the related circuit system.

In one embodiment, a user may manipulate a handwriting device to write in a three-dimensional space. During the writing process, a sensing circuit in the device is used to sense the behavior of rotation and movement. The method for identifying the handwriting track first samples rotation signals made by the handwriting device according to a sampling rate. The rotation signals may further render movement signals. Thus, a plurality of sampling values within a period of time may be obtained. The sampling value includes data of both rotation and movement. The positional relationship among the sampling values is directed to rhythm information. The rhythm information is related to variation of sampling values within a unit time. Therefore, a handwriting track may be drawn according to the rotation and movement data from the sampling values. The attribute of the handwriting track has the rhythm information. The data of rotation and movement of the handwriting device are generated by sampled angular velocity in a space and corresponding displacement of movement.

In one embodiment of the system, the main circuit modules include a control module and a data processing module. Further, the control module and the data processing module may be disposed in the handwriting device; alternatively, the handwriting device may merely have the control module, and the data processing task may be performed by an external device.

In one embodiment, the control module at least includes an angular velocity sensor, a micro-controller, and a transmission unit. The data processing module essentially has a sampling unit, a track computation unit and a comparison unit. The sampling unit is used to sample signals generated by the angular velocity sensor according to a sampling rate. The track computation unit is used to obtain a handwriting track from a plurality of sampling values generated by the sampling unit. After that, the comparison unit generates a comparison result comparing the handwriting track with data in the database.

The system for identifying a handwriting track provides several input modes including a signature mode. Under the signature mode, the handwriting track forms a signature which is used to compare with the signature file in a database to determine if the signature is matched. The input mode is such as a character-input mode. Under the character-input mode, the handwriting track forms an input character. An input character can be determined comparing the character tracks in the database. The input mode is such as a command mode. Under the command mode, the handwriting track forms an input command. An input command can be determined comparing with the tracks of commands in the database.

### BRIEF DESCRIPTION OF THE DRAWINGS

FIG. 1 shows a schematic diagram depicting the circumstance of identifying the handwriting track in accordance with the present invention;

FIG. 2 shows an angular velocity coordinates map adopted in the method for identifying a handwriting track in one embodiment of the present invention;

FIG. 3 shows the relationship of angular velocity and a handwriting track in one embodiment of the present invention;

FIGS. 4A to 4C show examples as drawing the handwriting tracks;

FIG. 5A shows a schematic diagram depicting the system for identifying a handwriting track in one embodiment of the present invention;

FIG. 5B shows a schematic diagram depicting the system in one further embodiment of the present invention;

FIG. 5C shows a schematic diagram depicting the system in another embodiment of the present invention;

FIG. 6 shows a flow chart describing the method for identifying the handwriting track in a first embodiment of the present invention;

FIG. 7 shows a flow chart describing the method for identifying the handwriting track in a second embodiment of the present invention;

FIG. 8 shows a flow chart describing the method for identifying the handwriting track in a third embodiment of the present invention;

FIG. 9 shows a flow chart describing the method for identifying the handwriting track in a fourth embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The disclosure is directed to a method for identifying a handwriting track and a system for implementing the method. When a user manipulates a handwriting device, the system samples the rotation and movement signals made by the device. The rotation and movement signals are related to angular velocity and angular displacement of waving the handwriting device. In addition to drawing a handwriting track, the system may acquire rhythm information associated with the track. For recognizing a handwriting signature, the rhythm information rendered from the signature may also be referred to for determining if the handwriting track matches a signature file. Therefore, the signature recognition technology can be more secured. More embodiments show other functions incorporating the system, e.g. the functions of character input and command input.

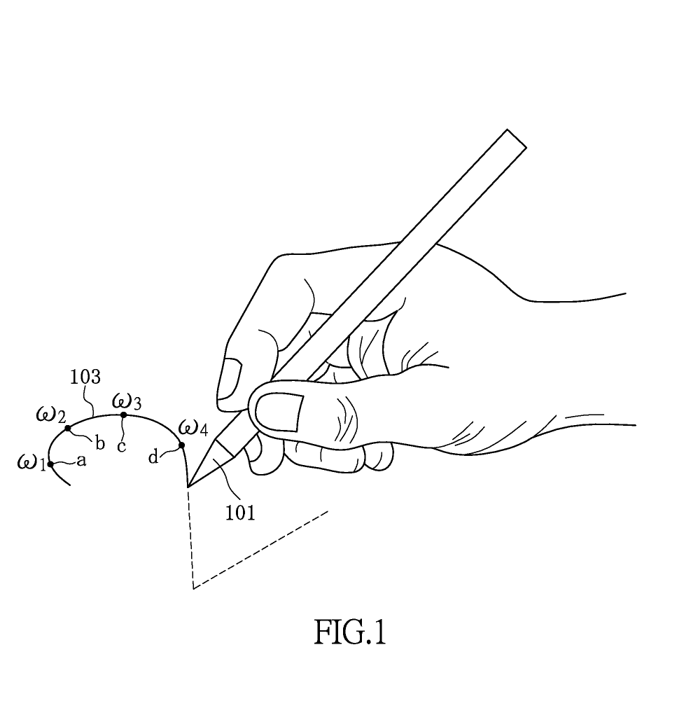

Reference is made to FIG. 1 illustrating a circumstance as implementing the method for identifying handwriting track in the disclosure.

An input device 101 is provided for a user to manipulate in a three-dimensional space. The input device 101 may be a pen-like handheld device for the user to hold the input device 101 waving in space. The sensors disposed in the input device 101 are used to sense the rotation signals of the device 101 and movement signals rendered by the rotation signals at every axial direction. The sensor for sensing rotation is such as an angular velocity sensor disposed in the input device 101. The angular velocity sensor is such as a gyroscope. The movement may be computed by the rotation signals. The equations 1 and 2 may be used to render the computation from rotation to movement signals. Alternatively, an accelerator in the input device 101 may also be used to calculate the movement signals.

In the present embodiment, a user holds an input device 101 to generate a handwriting track 103. The control circuit of the input device 101 is configured to have a sampling rate, namely the sampling number per unit time. The sensing circuit performs sampling according to the sampling rate. For example, the shown positions “a, b, c, and d” are the sampled points for forming the handwriting track 103. The rotation signals are generated based on the physical quantities of the sampling points a, b, c, and d. The physical quantities of the sampling points (a, b, c, d) may be calculated from the angular velocities ω₁, ω₂, ω₃, and ω₄.

The mentioned physical quantities obtained at different times are provided to render the vectors used to draw a handwriting track in the space. At the same time, a variation of the sampling values within a period of time may be obtained. The angular velocity per unit time may reflect the sampling variation. The variation may particularly denote the rhythm of a person signing his name or sketching a diagram. For a certain rhythm exists when people sign their name, and the rhythm can be one of the factors to verify the signature in addition to recognizing the handwriting track.

An angular velocity sensor may be incorporated to acquire the physical quantity of movement of the sampling point. The angular velocity sensor is such as a gyroscope disposed in the handwriting device which is used to sense the rotation signal within a period of time according to a sampling rate. The rotation signal may be represented by angular velocity. Every angular velocity value may indicate a track, e.g. an arc which is a part of the circumference of a curved line in the space. In one further embodiment, an accelerometer may also be employed in the device for acquiring the displacement of movement in the space.

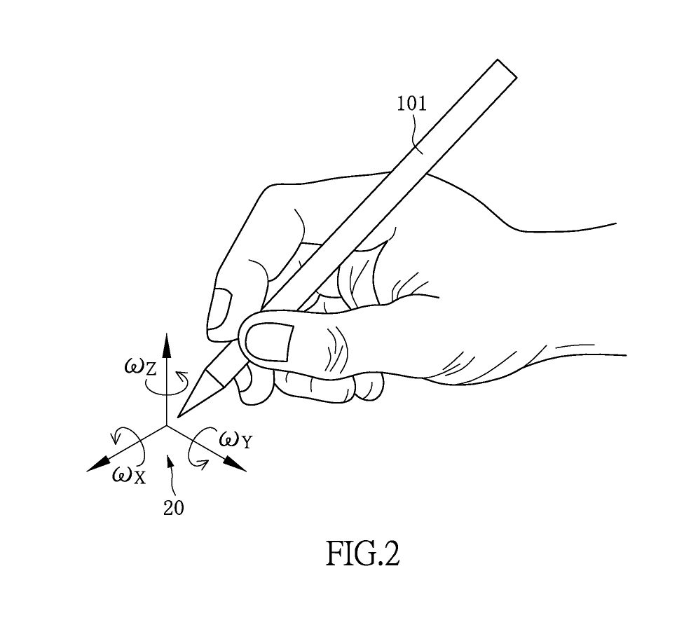

Reference is made to FIG. 2 introducing angular velocity coordinates to depict a handwriting device receiving physical quantities in the axial directions in a space.

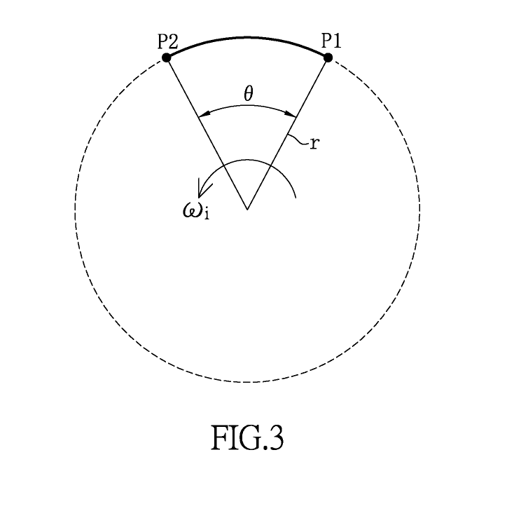

A coordinates 20 within a three-dimensional space is depicted. Every sampling value within the space may have angular velocity components ωₓ, ω_{y}, ω_{z} along the three axial directions. A vector set (ωₓ, ω_{y}, ω_{z}) indicates the physical quantity of one sampling point. Furthermore, the physical quantity of the sampling value is in conjunction with the rhythm information indicating variation of the physical quantities in a period of time. The angular velocity value reflects a track in the space. FIG. 3 shows a schematic diagram of the relationship of angular velocities and the track.

To incorporate the system to operate the handwriting, the system is configured to acquire multiple sampling points over multiple sampling periods according to the sampling rate. A sampling value is generated in a sampling period. Reference is made to FIG. 3. The handwriting device renders variation of the physical quantities in a three-dimensional space. Every sampling value includes a track start point P1 and a track end point P2 within a period of time. An angular velocity ωᵢ is formed as the movement is made from the track start point P1 to the track end point P2. In the rotation coordinates, the angular velocity value ωᵢ represents a rotation angle θ, that means the product of the angular velocity ωᵢ and time t. An arc length between the track start point P1 and the track end point P2 is the product of the rotation angle θ and the rotation radius r (r×θ). The symbol “×” means a cross operation, the rotation radius “r” is an adjustable system sensitivity parameter, and the time “t” is a time interval between two continuous sampling values, e.g. the time interval between the track start point P1 and the track end point P2. In one embodiment, the rotation angle components in the three axial directions may be represented in equation 1. The three rotation angle components are the movement components in the three axial directions if “r” equals to 1. Equation 2 shows the product of the rotation radius “r” and the rotation angle components.

θᵢ=ωᵢ×t, i=x, y, z (equation 1)

sᵢ=r×θᵢ, i=x, y, z (equation 2)

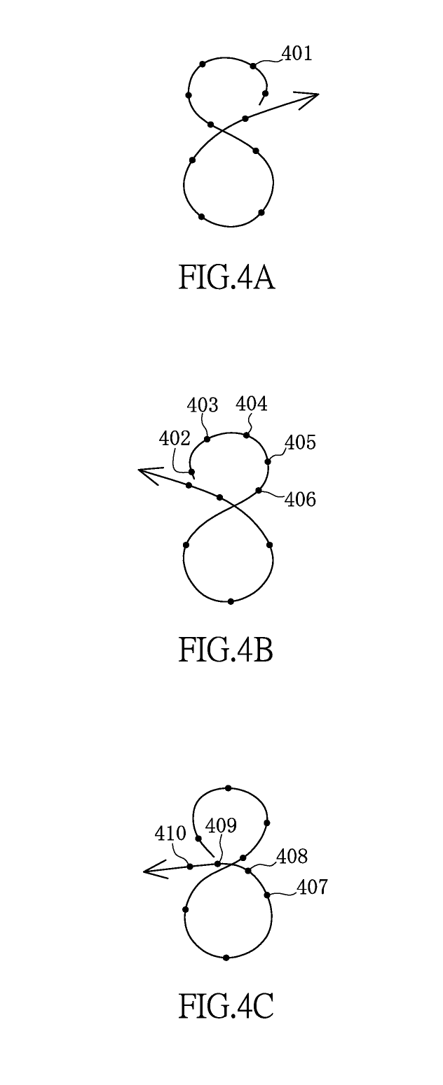

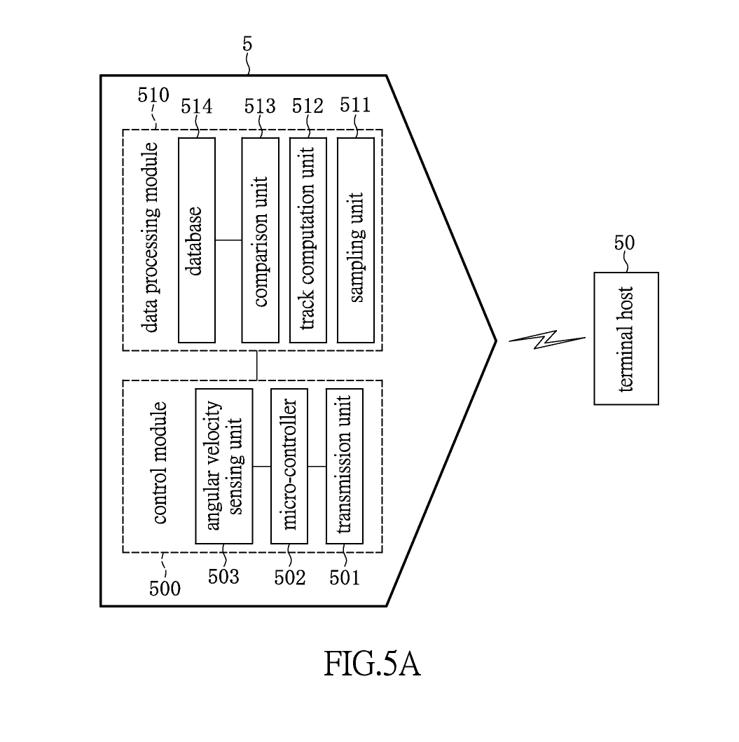

The method and system for identifying the handwriting track in the disclosure allows the user to draw a character, command or signature. For conducting in the signature mode, a database should record the user-registered signature files for some specific services in advance. Every word or stroke for every signature file includes a plurality of sampling values per unit time. The physical quantity for the sampling value may be angular velocity or angular movement. The variation of the sampling values at two unit times may be included. The variation indicates the rhythm of the signature. Therefore, the physical quantity and rhythm form important compositions of the handwriting. FIGS. 4A to 4C schematically show examples of handwriting tracks.

FIG. 4A shows a schematic diagram describing a user using a handwriting device having a sensor to draw a character “8” in a three-dimensional space. The system samples the sampling points 401 for the character according to a sampling rate which is configured to be a sampling velocity per unit time. The sampling points are arranged over the track of the character in a certain rhythm.

In FIG. 4B, it shows the same character “8” with different track direction drawn by a different person. Also, the physical quantities such as track vectors with the multiple sampling values are altered. Further, it has slower writing velocity handwriting the upper portion of the character. Under the same sampling rate, more sampling values with denser sampling points can be sampled. In the present example, the upper portion has the sampling points 402, 403, 404, 405, and 406. It is apparent the user uses faster writing velocity to handwrite the lower portion of the character. It therefore has fewer and more distanced sampling values under the same sampling rate. As a whole, variation occurs among the sampling values as the user writes the character in a specific rhythm.

In FIG. 4C, even though the handwriting track is similar to the track direction drawn in FIG. 4B when writing the same character “8”, it is apparently in a different rhythm. Handwriting the character “8” shown in FIG. 4C, the portion in the beginning is with faster velocity since the system acquires less sampling values in the period of time and the adjacent sampling points have a farther distance. On the contrary, at the end of writing the character, it is with slower velocity of writing since the sampling points 407, 408, 409, and 410 over the track of this portion are a little more and the distances between the adjacent sampling points (407, 408, 409, 410) are closer. The variation of the writing velocities obtained by these sampling values renders the rhythm information.

It is noted that, the number and positions of the mentioned sampling points is relevant to a sampling rate configured in the system. The higher sampling rate may obtain more precise determination of the written character or command, and also avoid the possibility of erroneous determination. Further, the system performs comparison between every sampling value and the track files recorded in the database. In the database, a series of physical quantities for characters are prepared for reproducing a handwriting track. More sampling values may reproduce more precise tracks.

A mapping process may be incorporated to find out the sampling rate with the most consistent sampling points recorded in the database as compared with the actual number of samples under an actual sampling rate. After that, the acquired sampling points under the closest sampling rate are used to check the actual sampling values.

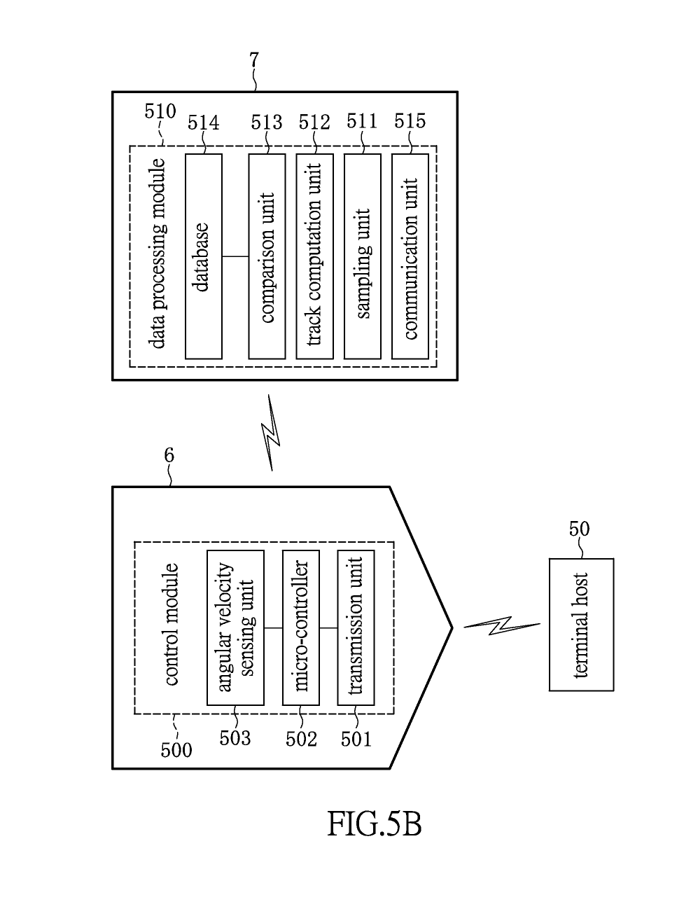

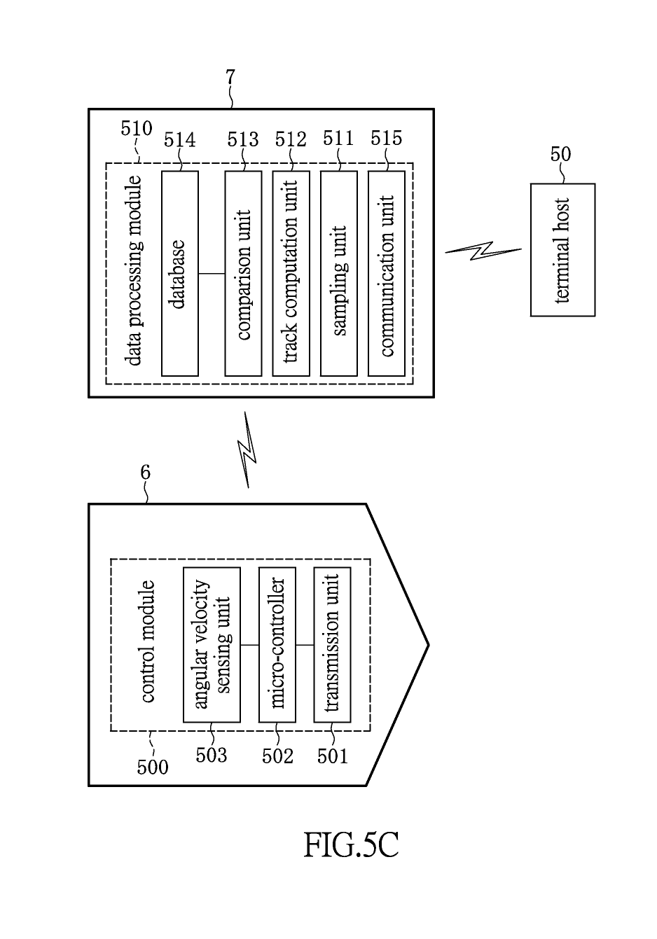

In order to implement the method for identifying the user's handwriting track, the control circuits, and sensors for getting the angular velocities, function modules for performing sampling and track comparison in the handwriting device are employed. The embodiment directed to the system for identifying a handwriting track refers to the functional blocks of the system described in FIG. 5A.

There are two main circuit modules disposed in the system. The system may be exemplarily embodied in a handwriting device 5. One of the modules is a control module 500 which is used to acquire the handwriting signals. The other one module is a data processing module 510 which is used to process the signals made by the control module 500.

Furthermore, the control module 500 and the data processing module 510 may be two separate circuit modules, or alternatively be integrated into one module. Thus, the handwriting device may itself sense the handwriting signals as the user manipulates the device. In the device, the modules may simultaneously output a comparison result. The comparison result is then transmitted to a terminal host 50 for performing a back-end process through a transmission unit 501. For example, the terminal host 50 is able to acquire a result made by the handwriting device when the device operates a signature file and performs comparison and identification. The terminal host 50 may then conduct a service. Alternatively, the terminal host 50 conducts an action such as receiving an input character or a command input from the handwriting device.

According to one of the embodiments of the system for identifying the handwriting track, the control module 500 at least includes an angular velocity sensor 503, a micro-controller 502, and a transmission unit 501. The angular velocity sensor 503 is such as a sensor disposed in the handwriting device for sensing the actions such as rotation and movement. When a user manipulates the handwriting device having the control module 500, the rotation and movement signals are generated. The micro-controller 502 is in charge of the operations of the circuits and processing the received signals. The angular velocity sensing unit 503 is electrically connected with the micro-controller 502. The micro-controller 502 is used to receive the sensing signals. The transmission unit 501 is also electrically connected with the micro-controller 502 for outputting the comparison result.

The data processing module 510 is a circuit module electrically connected with the control module 500. The data processing module 510 and the control module 500 may share the circuit module, e.g. the micro-controller 502. One of the main circuit modules in the data processing module 510 is a sampling unit 511 electrically connected with the micro-controller 502. The sampling unit 511 samples the signals generated by an angular velocity sensor 503 in response to a sampling rate. The data processing module 510 has a track computation unit 512 electrically connected with the micro-controller 502. The track computation unit 512 is used to extract a handwriting track based on the sampling values provided by the sampling unit 511. The track computation unit 512 is used to compute the variations among the physical quantities of the sampling values, e.g. the positional relationship among the sampling values.

The variations among the sampling values imply a kind of rhythm information associated with the handwriting track. The rhythm information may be defined as the variations of the sampling values per unit time. A comparison unit 513 electrically connected with the micro-controller 502 is included. Responsive to user's request, the comparison unit 513 in the data processing module 510 is in charge of comparing the handwriting track with the introduction of a database 514 under a system's operating mode. After that, a comparison result is then generated.

The system may be operated under several operating modes, such as a signature mode, a character-input mode, and a command mode. The database 514 correspondingly recodes the handwriting track data by forms of the signature files, character files and command files. The handwriting track data also derives the handwriting rhythm information.

In FIG. 5B, the diagram exemplarily shows the functional blocks depicting the system for identifying a handwriting track in one embodiment of the present invention.

A control module 500 shown in the diagram may be disposed in the handwriting device 6. On the contrary, the data processing module 510 in this aspect is an external device 7. That means the control module 500 directly senses the signals made by a handwriting motion when the user operates the handwriting device 6. The signals are then transmitted to the external data processing module 510. The data processing module 510 is used to process the movement data computed from the rotation and movement signals generated by the handwriting device 6. When the data is processed by the data processing module 510, a comparison result is generated. The result may lead to a signature verification, an input character, or an input command. Through a transmission means, e.g. a communication unit 515, the comparison result may be firstly transmitted to the control module 500 of the handwriting device 6, and then to the terminal host 50 for processing the further process.

In the present embodiment, the control module 500, as described in FIG. 5A, may have the angular velocity sensor 503 capable of sensing rotation signals generated by operating the handwriting device 6, the micro-controller 502 for processing the signals in the device, the data processing module 510, and the transmission unit 501 for transmitting data to the terminal host 50. It is noted that the micro-controller 502 is the control circuit for processing received signals, e.g. outputting the comparison result.

The main circuits in the data processing module 510 are exemplarily depicted in FIG. 5A. The data processing module 510 is disposed in the external device 7 which independently conducts data computation according to the present embodiment. The data processing module 510 has a sampling unit 511 which is used to sample the rotation signals generated by the angular velocity sensor 503 in response to a sampling rate. The data processing module 510 includes a track computation unit 512 for making the handwriting track from the sampling values. A comparison unit 512 for introducing a database 514 for track comparison is also included. In addition, a communication unit 515 for wireless communication may be included. The communication unit 515 is used to co-operate the control module 500 in the handwriting device 6, for example to receive the comparison result in the control module 500. The transmission unit 501 is used to transmit the comparison result to the terminal host 50.

In an exemplary embodiment of the system, a communication channel is established between the external device 7 having the data processing module 510 and the terminal host 50. According to the embodiment shown in FIG. 5C, compared with the embodiment of FIG. 5B, the control module 500 is still in the handwriting device 6, and the data processing module 510 is in the external device 7. The rotation signals and the related movement signals computed from the rotation signals are generated by the handwriting device 6. The difference between the embodiments of FIG. 5B and FIG. 5C is that the data processing module 510 samples and processes the signals from the control module 500. The data processing module 510 also finds the comparison result for comparing the signals. The comparison result is then transferred to the terminal host 50 via a communication unit 515. It is noted that the control module 500 and the data processing module 510 described in the embodiments of FIGS. 5B and 5C are respectively disposed in the handwriting device 6 and the external device 7. The communication there-between is performed by the transmission unit 501 and the communication unit 515 respectively. The communication may be made by wired or wireless connection.

Applying the system described above, the system may operate under a signature mode. Meantime, the system asks the user to make a signature such as signing his user identification. Then the system recognizes the signature by comparing the handwriting track with the corresponding track associated with the user identification recorded in the database 514. Further, when the system operates under a character-input mode, the input handwriting track is sequentially compared with the track data of characters recorded in the database 514. The track data in the database 514 is such as physical quantities associated with the sampling points. The physical quantities are in sequence compared with sampled signals of the handwriting track. The comparison results in differences at the sampling points of every character in the database 514 under the character-input mode. After that, the character with the minimum total difference is regarded as the input character. One of the embodiments for computing the total difference is equation 3.

$$E = {\sum }_{j = 1}^{{P}_{input}} \sqrt{{( {x}_{j , input} - {x}_{j , base} )}^{2} - {( {z}_{j , input} - {z}_{j , base} )}^{2}} \qquad ( Equation 3 )$$

Equation 3 indicates a total difference (E) as summing up the differences with respect to straight distances between the coordinates of sampling points and the coordinates of the character tracks. It is noted that the coordinates of the sampling point can be represented as x_{j,input}, z_{j,input} over an X-Z plane. The coordinates of a character in the database 514 can be represented as x_{j,base}, z_{j,base}. This total difference (E) is a difference reference for recognizing the character.

Under a command mode, the comparison scheme is similar to the method for character recognition. The handwriting track for inputting command is not directed to a specific character, but just a gesture or symbol acting as an input command.

It is noted that the circuit blocks are not limited to the example shown in FIG. 5. FIG. 5 schematically shows the main circuits for implementing the system.

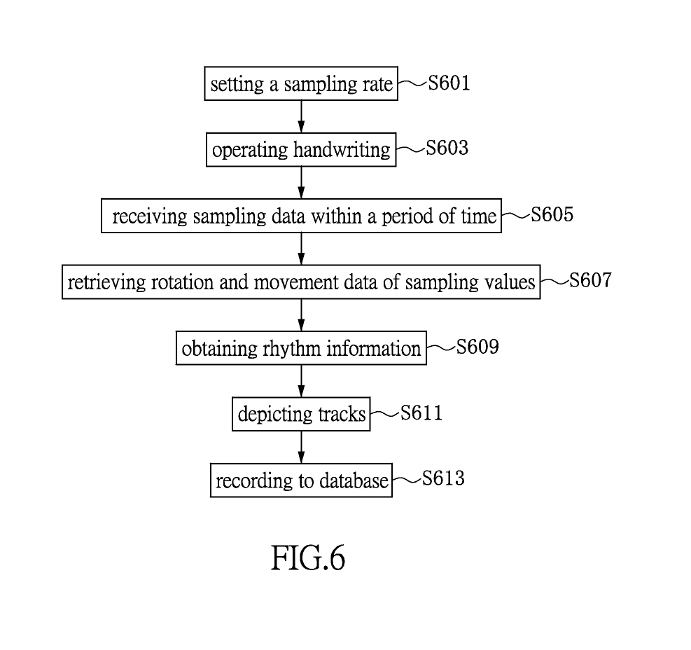

Reference is made to FIG. 6 showing a flow describing the method for identifying a handwriting track in one embodiment of the present invention.

In the beginning, such as step S601, the system sets a sampling rate acting as timing to sample the physical quantities over a track. The user manipulates the handwriting device with the sensors to write in a space. In step S603, the operating system is able to receive the signals sensed by the sensors within the device. The system performs sampling to the rotation signals generated by the handwriting device according to the sampling rate. The rotation signals are then derived to have the movement signals. In step S605, the sampling data within a period of time is received.

Next, in step S607, the system extracts the physical quantities from the retrieved rotation and movement data of the sampling values. For example, the physical quantities are such as angular velocity and angular displacement which are retrieved from the handwriting device moving within a space. Then the rhythm information may be extracted from the positional relationship among the plurality of sampling values, in step S609. The physical quantities associated to the sampling values are referred to in order to retrieve the information for depicting the handwriting track, in step S611. In the information for depicting the handwriting track based on the sampling values, the rhythm information is included. The rhythm information with respect to the handwriting track is then recorded in the database, in step S613.

The database records the user-related handwriting track in advance. The records in the database are provided to verify the signature when the system is under the signature mode. The handwriting track recorded in the database is in the form of a vector set. The record in the database includes the rhythm information unique to every user in addition to the sampling values over the track.

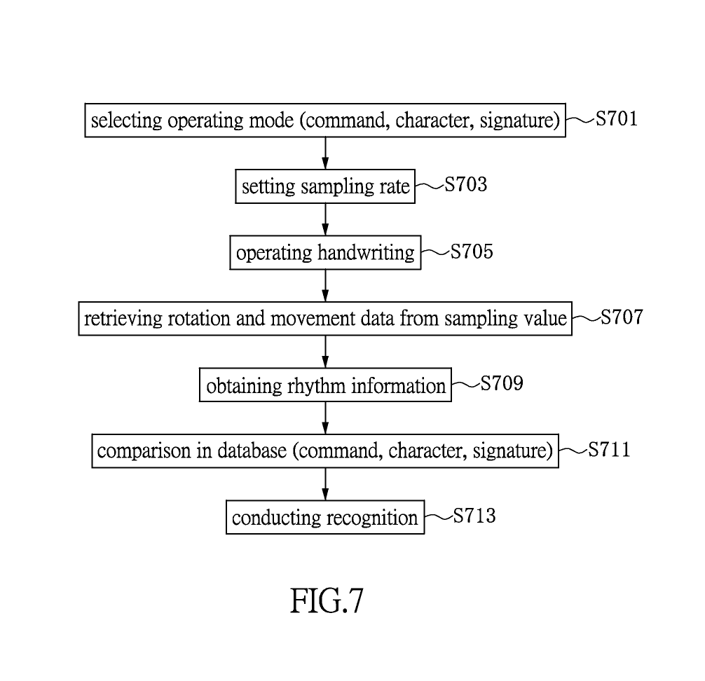

Reference is made to FIG. 7 showing one more flow chart illustrating an embodiment of the method for identifying the handwriting track.

The flow chart shows some operating modes supported by the system in accordance with the present invention. In step S701, one of the operating modes including a command mode, a character-input mode, and a signature mode is selected. Thus, the system may be one of the operating modes according to the user's request or for any purpose. For example, under the command mode, the adoption of data in the database relates to the track data of kinds of commands for a specific purpose. Under the character-input mode, the track data associated to the characters in the database is employed. It is noted that the track data of characters in the database are related to the kinds of language letters, numerals and symbols. Under the signature mode, the system may ask you to show your own identity, for a user's specific purpose of use such as logging in a computer. Meanwhile, the track data related to the user's signature in the database will be incorporated for the identification.

Next, in step S703, the system sets a sampling rate. In step S705, the user manipulates the handwriting device. The system therefore retrieves sampling values of the handwriting track within a period of time in response to the sampling rate. The system also obtains the physical quantities related to the rotation and movement. In step S707, the system retrieves the rotation and movement data from sampling values. The variations of the physical quantities among the sampling values are obtained. The variations render the rhythm information, in step S709.

Next, incorporation of the data in a database is based on the present purpose of the handwriting operation. The system therefore acquires the numerical values corresponding to the track data retrieved from the database. For example, in step S711, the system performs comparison with the database to acquire the track data with respect to commands, characters, or signatures. The comparison result can be obtained since the system conducts the recognition among the commands, characters, or signatures, such as in step S713.

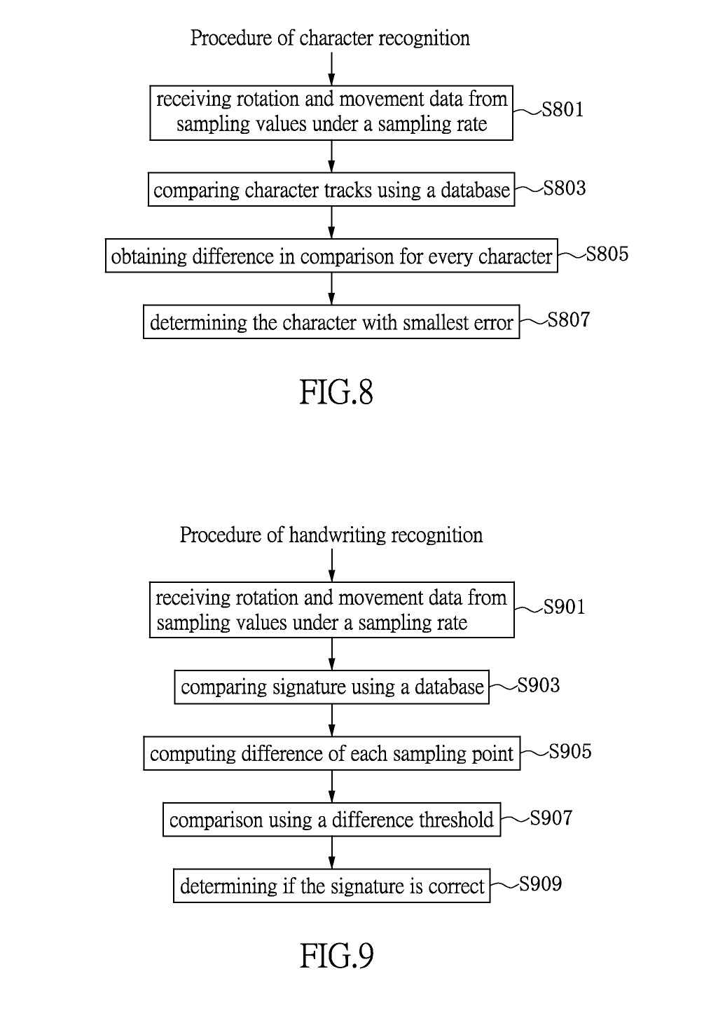

FIG. 8 shows a flow illustrating the procedure under a character-input mode in one embodiment of the method for identifying the handwriting track.

The system acquires a plurality of sampling values associated with the sampling points within a period of time of inputting the character according to a sampling rate. In step S801, the rotation and movement data are extracted from the sampling values. The track data corresponding to the purpose of character-input is obtained from the database. In step S803, the sampling values are compared with the character tracks in the database. After finding out the mapping numerical values of the characters in the database, the sampling values of the handwriting track are one-by-one compared with the numerical values of every character. The differences may then be computed by the comparison performed upon the handwriting track with the track data in the database. In step S805, a total difference by point-to-point comparison can be obtained for every character, namely the physical quantities are compared with every character's physical quantities recorded in the database. The total difference is a summation of the differences of every character's comparison. After that, the system may regard the comparison result with a minimum total difference as the final result which also specifies one of the characters. In step S807, the character with the minimum difference is determined.

The above description may be applied to another mode such as the command mode. On the contrary, the recognition under the command mode is not limited for any character or symbol, but for a requirement of a terminal host. The relevant handwriting track may correspond to a specific gesture. Under this command mode, the handwriting track may form an input command. This input track is compared with the track data of commands in the database so as to determine the input command. Similarly, the sampling values may be extracted from the handwriting track, and are compared with the track values for the commands recorded in the database. A total difference is therefore computed as summing up the differences comparing the sampling values with the command tracks in the database. The input command with the minimum total difference is regarded as the input command in the system.

Further reference is made to FIG. 9 depicting a flow which is used to illustrate one of the embodiments of the method in the present invention. When the system is under a signature mode, the relevant handwriting track regards a signature which is corresponding to one of the signature files in the database. In the flow chart, the method is to recognize the handwriting track by determining if the track made by the handwriting device matches any signature file.

In the process of identifying the signature, in the beginning of step S901, the system receives rotation and movement data from the sampling values extracted under a sampling rate. The sampling values are the physical quantities extracted from the handwriting track. In the meantime, such as in step S903, the sampling values are compared with the signature file in the database. The signature file may be selected made by the user using the system before making the handwriting track. The signature file is also compared with the corresponding values under the consistent sampling rate. The sampling values correspond to the specific positions over the handwriting track by a matching process. The matching process allows the system to retrieve the sampling values from the handwriting track and perform comparison with the signature file in the database. After one-by-one comparison performed upon the sampling values, such as in step S905, the differences can be computed for every sampling point. In step S907, the system determines if the total difference exceeds a difference threshold set by the system. The total difference is computed from the multiple sampling values compared to the values over the track value in database. In step S909, the system determines if the signature is correct. When the total difference is smaller than the difference threshold, it is determined that the handwriting signature matches the signature file.

In the step for determining if the handwriting signature matches the specific signature file, the system may simultaneously consider the rhythm of the personal signature. It is also noted that the rhythm information refers to the positional relationship among the sampling values over the handwriting track. On the contrary, the signature file recorded in the database includes the other rhythm information over the track value. Therefore, the difference between the present handwriting rhythm information and the rhythm information associated with the signature file may be regarded as one of the parameters for making the determination. The rhythm information may enhance the security by identifying the signature in addition to considering the difference threshold.

Thus, according to the aforementioned embodiments of the method and system for identifying the handwriting track, the system is allowed to receive the sampling values from the physical quantities manipulating the handwriting device based on a sampling rate. The variations of the physical quantities between the adjacent sampling values further render the rhythm information. The recognition of signature, input command or character from the handwriting track can consider the differences of the sampling values as well as introduce the rhythm information.

It is intended that the specification and depicted embodiment be considered exemplary only, with a true scope of the invention being determined by the broad meaning of the following claims.

What is claimed is:

1. A method for identifying a handwriting track, comprising:
in response to a sampling rate, sampling rotation and movement signals generated by a handwriting device, so as to obtain sampling values within a period of time;
acquiring physical quantities indicative of rotation and movement signals in every sampling value;
obtaining rhythm information according to positional relationships among the sampling values; and
acquiring information of the handwriting track according to physical quantity of the sampling values; wherein the information of the handwriting track includes the rhythm information.

2. The method according to claim 1, wherein the physical quantity includes angular velocity and corresponding movement when the handwriting device moves in a space.

3. The method according to claim 2, wherein a distance of the movement is represented by a rotation angle, and the rotation angle is a product of the angular velocity and a time interval between two adjacent sampling values.

4. The method according to claim 3, wherein the angular velocity is produced by an angular velocity sensing unit disposed in the handwriting device.

5. The method according to claim 1, wherein, under a signature mode, the handwriting track forms a signature with respect to a signature file recorded in a database, so as to recognize if the handwriting track made by the handwriting device matches the signature file.

6. The method according to claim 5, wherein the handwriting track includes a plurality of sampling values and the signature file in the database has a plurality of track values; it is determined that the handwriting track matches the signature file if a total difference as comparing the sampling values with the track values is smaller than a threshold.

7. The method according to claim 6, wherein the positional relationships among the sampling values of the handwriting track records the rhythm information; the track values of the signature file in the database has another rhythm information; and a difference comparing the rhythm information with the another rhythm information acts as one of the parameters to judge if the handwriting track matches the signature file.

8. The method according to claim 7, wherein, variations of the sampling values within a unit time define the rhythm information.

9. The method according to claim 1, wherein, under a character-input mode, the handwriting track forms an input character; to determine the input character by comparing the input character with tracks for characters recorded in a database.

10. The method according to claim 9, wherein the input character includes a plurality of sampling values sensed within the period of time; the track for every character in the database includes multiple track values; the input character is determined when a total difference between the plurality of sampling values and the track values for every character is minimum.

11. The method according to claim 1, wherein, under a command mode, the handwriting track forms an input command; to determine the input command by comparing the handwriting track with tracks of commands recorded in a database.

12. The method according to claim 11, wherein the input command includes a plurality of sampling values sensed within the period of time; the track for every command recorded in the database has track values; the input command is determined when a total difference between the plurality of sampling values and the track values for each command is minimum.

13. A system for identifying handwriting track, comprising:
a control module, disposed in a handwriting device, at least including an angular velocity sensor, a micro-controller and a transmission unit; wherein the angular velocity sensor is used to sense rotation made by the handwriting device so as to generate rotation signals;
a data processing module, comprising:
a sampling unit, sampling the rotation signals according to a sampling rate, so as to acquire a plurality of sampling values within a period of time;
a track computation unit, computing a handwriting track based on the sampling values; wherein a positional relationship among the sampling values has rhythm information; and
a comparison unit, generating a comparison result by comparing the handwriting track with data in a database.

14. The system according to claim 13, wherein, a terminal host performing a back-end process receives the comparison result.

15. The system according to claim 14, wherein the control module and the data processing module are disposed in the handwriting device; and the comparison result is transmitted to the terminal host from the handwriting device.

16. The system according to claim 14, wherein control module is disposed in the handwriting device, and the data processing module is an external device which is used to process rotation signals made by the handwriting device and movement signals computed from the rotation signals; the control module receives the comparison result generated by the data processing module and transmits the comparison result to the terminal host.

17. The system according to claim 14, wherein the control module is disposed in the handwriting device, and the data processing module is an external device which is used to process rotation signals made by the handwriting device and the movement signals computed from the rotation signals; the data processing module has a communication unit which is used to transmit the comparison result to the terminal host.

18. The system according to claim 13, wherein the database records users' signature files, character file or/and command file related to handwriting track.

19. The system according to claim 18, wherein the database further records the users' handwriting rhythm information, and the rhythm information reflects variation of the sampling values within a unit time.
